(19) United States
(12) Patent Application Publication
(10) Pub. No.: US 2013/0048029 A1
(43) Pub. Date: Feb. 28, 2013

(54) Methods of controlling ice dams, and product combinations for controlling ice dams

(71) Applicant: Peter J. Vercouteren, Fond du Lac, WI (US)

(72) Inventor: Peter J. Vercouteren, Fond du Lac, WI (US)

(21) Appl. No.: 13/199,158

(22) Filed: Aug. 22, 2011

(51) Int. Cl. B08B 3/00; C09K 3/18

(52) U.S. Cl. 134/26; 252/70

(57) ABSTRACT

In treating ice dams, a more aggressive de-icing agent creates an initial breach in the dam, followed by treatment with a less aggressive de-icing agent to maintain and grow the breach. Depending on quantities, and specific materials used, that portion of the ice dam which will be removed may be removed in several hours, several days, or a few weeks, also depending on the aggressiveness of the less aggressive agent. Where moderately aggressive de-icing agent is used as the second step, slow-acting de-icing agent can be applied as a third step. De-icing agents can be applied in any order, so long as the moderately aggressive agent and/or slow acting agent are applied soon enough to avoid re-closure of paths already created. A product combination comprises a very aggressive de-icing agent, a less aggressive agent, and instructions specifying use of both agents to breach and maintain an ice dam.

### BACKGROUND OF THE INVENTION

This invention relates to removal of ice dams. More specifically, this invention relates to methods for breaching, and optionally removing, an ice dam, along with a product combination used in the method.

Ice dams tend to build up near an edge of a sloped roof on a building, such as on an overhang or an eave. Ice dams also build up adjacent a roof drain or a gutter. Such build-up near a roof edge or roof drain may be related to the roof areas around roof edges or roof drains generally receiving less heat from inside the building, than other portions of the roof. Consequently, as heat rises within and/or from the building on one portion of the roof, or as solar energy melts snow and/or ice on one portion of the roof, the snow and/or ice receiving such heat tends to melt and run along the outer surface of the roof toward the eaves or the drain, where such water may re-freeze, resulting in an ice build-up. As this process continues, the ice build-up can form an ice dam, and water subsequently running along the outer surface of the roof in the same region as the ice dam begins to pool, and back up above the ice dam, whereby the pool can grow laterally, including underneath the roof shingles/panels, such that the backed-up pool of water may extend beyond underlying edges of the roof shingles/panels, thus entering the building.

Given that ice dams initially form in the gutter when the roof temperature is warm enough that snow or ice on the roof can melt on the roof, such melting, and creation of ice dams, and running of water into the building, tends to happen when the ambient air temperature is below the freezing temperature of 32 degrees F.

Such water entrance into the building from the roof can cause significant damage on the interior of the building. If the ice dam is not removed, and given suitable outside weather conditions, water continues to run down the roof and solidify at the ice dam, such that the ice dam continues to grow, blocking the ability of the running water to reach the drains. More water continues to collect, more ice forms, the back-up pool continues to collect water, and water continues to run into the building, whereby the amount of damage to the interior of the building continues to grow.

Currently there are relatively few known products and/or methods available for removing ice dams.

Most such products and/or methods have met with little or no success, or are so costly to implement as to be impractical for the average residential user. For example, manually hammering or chipping at the ice dam is known. Also, removal methods utilizing electric resistance heaters, steam, and torches are known. Such options are time consuming and expensive to implement. Some known removal methods risk damage to the roof and/or gutter and/or involve safety hazards to those implementing such methods.

It is also known to use salt (sodium chloride) brine which is formed when salt is mixed with water. However, salt brine is corrosive to metal gutters, drain pipes and other metal structures with which it comes in contact. In addition, the salt brine is toxic to vegetation, doing damage to nearby grass, trees, shrubbery and other plant life. Unless special care is taken to control the distribution of such toxic salt brine, substantial damage can be done to the lawns, trees and shrubbery adjacent its use, since many drains discharge into a vegetation-supporting soil adjacent the respective building.

It is also known to apply a porous package, containing a mixture of chloride salts, at the location of the ice dam, such that water entering the porous package contacts with the chloride salts and forms a brine which gradually penetrates the ice dam. However, such brining process takes a relatively long time considering that water may already be running into the building. In addition, while certain chloride products are less corrosive to metal than is sodium chloride brine, all chloride brines are known to have toxic effects on certain varieties of vegetation.

Thus, it is desirable to provide a fast acting de-icing agent for use in breaching an ice dam so as to allow water to quickly drain, along the outer surface of the roof, from any pool of water which collects above such ice dam.

It is further desirable to provide a fast acting method of breaching such ice dam.

It is further desirable to provide a such fast acting de-icing agent which is not harmful to vegetation and which is not corrosive to the roof-and-gutter environment.

It is still further desirable to provide a method of opening further drainage paths, or of further opening the path created by the breach in the ice dam initiated by the fast-acting de-icing agent, along with a material capable of further opening the path created by the breach and/or capable of creating such further drainage paths.

It is further desirable to provide a product combination, and methods of use, which can quickly breach the ice dam, quickly allowing water to flow through and/or past the ice dam, then expand the flow path and/or create new flow paths.

These and other needs are satisfied, or the negative effects are at least attenuated, or partially or completely satisfied or attenuated, by the novel products and methods of the invention.

### SUMMARY OF THE INVENTION

In treating ice dams on sloping surfaces, in a first step, a very aggressive de-icing agent is used to create an initial breach in the ice dam. As a second step, a longer lasting de-icing agent is applied to the ice dam, to expand the breach created by the very aggressive de-icing agent, and to begin substantially reducing the overall mass of the ice dam. Depending how much of the longer lasting de-icing agent is used, most or all of the mass of the ice dam which will be removed may be removed in a matter of several hours, or several days or a few weeks, depending on the aggressiveness of the longer lasting de-icing agent being used. Where a moderately aggressive solid state de-icing agent is used as the second step, a slow-acting solid state de-icing agent can be applied as a third step above the ice dam to further break down the ice dam as well as to avoid/attenuate future re-building of the ice dam by future flows of melted water running down the slope. The two, or three, materials are applied in no particular order, so long as the moderately aggressive de-icing agent and/or the slow acting de-icing agent are applied soon enough to prevent re-closure of the paths created by the very aggressive de-icing agent. The moderately aggressive de-icing agent and/or the slow acting de-icing agent can be applied before the very aggressive de-icing agent is applied. The slow acting de-icing agent provides an ice avoidance feature by using a brine-producing material which dissolves slowly when in contact with water, to provide a brine, delivered to the location being treated over a relatively longer period of time, such as several months.

In a first family of embodiments, the invention comprehends a method of controlling an ice dam at a given location on a sloped surface during an icy period of time. The ice dam has a top. The method comprises applying a very aggressive liquid de-icing agent, having a freezing point temperature colder than −40 degrees Fahrenheit, to the ice dam in such amount that the liquid de-icing agent promptly breaches the ice dam and begins a flow of liquid from the ice dam; and applying, to the ice dam, an effective amount of a moderately aggressive, granular de-icing agent, the moderately aggressive, granular de-icing agent, in combination with atmospheric water, developing a liquid brine which is effective to cause melting of at least a further portion of the ice dam, in addition to the breach effected by the very aggressive liquid de-icing agent.

In some embodiments, the sloped surface is part of a roof of a building, at least a portion of the ice dam being on the roof, the building further comprising a gutter receiving water from the edge of the roof, and a downspout receiving such water from the gutter, the applying of the very aggressive liquid de-icing agent to the ice dam comprising applying the very aggressive liquid de-icing agent to the ice dam at at least one of (i) on the roof, (ii) in the gutter, and (iii) in the downspout.

In some embodiments, the method further comprises, in addition to applying a moderately aggressive, granular, de-icing agent and a very aggressive liquid de-icing agent, applying a slow-acting de-icing agent to the sloped surface on, or above, the ice dam location, the slow-acting de-icing agent, in combination with water, snow, or ice, gradually liquefying, and reaching the ice dam location, thus attenuating any tendency for further development of an ice dam at such location.

In some embodiments, the method comprises placing, on the roof, as the granular slow-acting de-icing agent, a packaged product comprising at least an effective amount of slow-acting de-icing agent in a closed porous flexible packaging container.

In some embodiments, the very aggressive liquid de-icing agent comprises liquid potassium acetate as a saturated solution in water and having a freezing point temperature no warmer than about −40 degrees, optionally about −50 degrees, optionally about −55 degrees, optionally no warmer than −75 degrees, Fahrenheit.

In some embodiments, the method includes removing the package, containing a remainder portion of the slow-acting de-icing agent, from the roof at the end of the icy period of time, and re-positioning the same package of slow-acting de-icing agent on the roof proximate the beginning of a next icy period of time. In some embodiments, the moderately aggressive, granular de-icing agent comprises sodium acetate and has a freezing point temperature in a saturated water solution of no warmer than about −10 degrees Fahrenheit, applied in an amount sufficient to accommodate continued at least temporary flow of liquid through the ice dam after the flow of the very aggressive liquid de-icing agent has ceased.

In some embodiments, the slow acting de-icing agent comprises calcium magnesium acetate.

In some embodiments, the method comprises applying the very aggressive liquid de-icing agent to the ice dam both at the roof and in the gutter downstream from the locus of application on the roof, optionally at spaced locations between the ice dam and the downspout, optionally in the downspout, the spacings in the gutter, in combination with any application in the downspout, being effective to start flow of liquid to the downspout from a location in the gutter proximately below the ice dam.

In some embodiments wherein the sloped surface is defined as part of the gutter below a sloped roof, at least a portion of the ice dam being in the gutter, the method comprises pouring the very aggressive liquid de-icing agent into the gutter, optionally at spaced locations upstream of a corresponding downspout, such that the very aggressive liquid de-icing agent reaches, and breaches, the ice dam, and applying the moderately aggressive granular de-icing agent into/onto at least one of the gutter, or the roof above the gutter, in an amount sufficient to accommodate continued flow of liquid brine through the ice dam after the flow of very aggressive liquid de-icing agent has ceased, optionally applying a slow-acting granular de-icing agent to at least one of the gutter or the roof above the gutter, the slow-acting granular de-icing agent, in combination with atmospheric water, gradually liquefying and reaching the ice dam location, thus attenuating any tendency for further development of an ice dam at such location.

In some embodiments, the sloped surface is defined as part of a gutter below a sloped roof, at least a portion of the ice dam being in the gutter, the method comprising applying the moderately aggressive de-icing agent into/onto at least one of (i) the gutter, and (ii) the roof above the gutter, in an amount sufficient to accommodate continued at least temporary flow of liquid brine through the ice dam after the flow of very aggressive liquid de-icing agent has ceased.

In a second family of embodiments, the invention comprehends a method of controlling an ice dam at a given location on a sloped surface during an icy period of time. The ice dam has a top. The method comprises applying a very aggressive liquid de-icing agent, having a freezing point temperature colder than −40 degrees Fahrenheit, to the ice dam in such amount that the liquid de-icing agent promptly breaches the ice dam and begins a flow of liquid from the ice dam; and applying, to the ice dam, an effective amount of a slow acting, granular de-icing agent, the slow acting, granular de-icing agent, in combination with atmospheric water, developing a liquid brine which is effective to cause melting of at least a further portion of the ice dam, in addition to the breach effected by the very aggressive liquid de-icing agent.

In some embodiments, the sloped surface is part of a roof of a building, at least a portion of the ice dam being on the roof, the building further comprising a gutter receiving water from the edge of the roof, and a downspout receiving such water from the gutter, the applying of the very aggressive liquid de-icing agent to the ice dam comprising applying the very aggressive liquid de-icing agent to the ice dam at at least one of (i) at the ice dam on the roof, (ii) at the ice dam in the gutter, and (iii) at the ice dam in the downspout.

In some embodiments, the sloped surface is defined in a gutter below a sloped roof, at least a portion of the ice dam being in the gutter, the method comprising pouring the very aggressive liquid de-icing agent into the gutter such that the very aggressive liquid de-icing agent reaches, and breaches, the ice dam, and applying the water permeable package, containing the slow acting granular de-icing agent, optionally comprising calcium magnesium acetate, into/onto at least one of the gutter, or the roof above the gutter.

In a third family of embodiments, the invention comprehends, in a gutter and downspout combination, receiving run-off from a roof, a method of breaching an ice dam in the gutter and downspout combination and thereby re-starting flow of aqueous liquid through the gutter and downspout combination. The method comprises as a first step, applying a very aggressive liquid de-icing agent, having a freezing point temperature colder than −40 degrees Fahrenheit, to the ice dam, including on any ice dam element in the gutter, at spaced locations along the length of the gutter, as well as on any ice dam blockage in the downspout, in such amount that the very aggressive liquid de-icing agent breaches the ice dam and begins a flow of liquid from the ice dam; and applying, as a second step, and in no particular order, an effective amount of either a moderately aggressive, granular de-icing agent or a slow acting de-icing agent, at at least one of (i) a relatively upstream portion of the gutter, or (ii) a portion of the roof proximate a relatively upstream portion of the gutter, the moderately aggressive, granular de-icing agent, or slow acting granular de-icing agent, being effective, in combination with liquid water, snow, or ice, with which such moderately aggressive de-icing agent, or slow acting granular de-icing agent, is in contact, to develop a liquid brine which causes melting of the ice dam sufficient to accommodate continued at least temporary flow of liquid through or around the ice dam.

In some embodiments, the de-icing agent applied in the second step is a moderately aggressive granular de-icing agent, further comprising, in addition to applying the moderately aggressive granular de-icing agent and the very aggressive de-icing agent, as a third step, applying a slow-acting granular de-icing agent to the roof proximate, and above, the gutter and upstream from the downspout.

In some embodiments, the invention comprehends a product combination, comprising a first container comprising a very aggressive liquid de-icing agent having a freezing point temperature colder than about −40 degrees Fahrenheit; a second container comprising one or more of a moderately aggressive, granular de-icing agent having a freezing point temperature no warmer than about -10 degrees Fahrenheit, or a slow acting de-icing granular de-icing agent having a freezing point temperature no warmer than about +10 degrees Fahrenheit; and instructions specifying pouring a quantity of the very aggressive de-icing agent such that the very aggressive de-icing agent arrives at an ice dam and thereby initiates liquid flow in breach of the ice dam, and placement of the respective moderately aggressive de-icing agent and/or slow acting de-icing agent relative to the ice dam so as to maintain flow of a liquid brine after depletion of that flow which was initiated by the very aggressive liquid de-icing agent.

In some embodiments, the second container comprises such moderately aggressive de-icing agent, the product combination further comprising a slow-acting granular de-icing agent in a second closed package comprising porous flexible sheet material, the instructions specifying placement of the closed package of the slow-acting de-icing agent relative to the ice dam so as to maintain capacity for low-rate liquid flow from the closed package of slow-acting de-icing agent, with reduced potential for ice dam build-up, after depletion of the moderately aggressive de-icing agent.

In some embodiments, the second container comprises both the moderately aggressive de-icing agent and the slow acting de-icing agent, the instructions specifying placement of the closed package so as to provide for a continuing flow of liquid brine after depletion of an applied quantity of the very aggressive liquid de-icing agent.

### BRIEF DESCRIPTION OF THE DRAWINGS

FIG. 1 shows a pictorial view of a building having an ice dam in a valley at the edge of the roof.

FIG. 2 shows an end view of the ice dam on the building, and a very aggressive liquid de-icing agent being applied to a small pool of water in a depression in the ice above the ice dam.

FIG. 3 is an end view as in FIG. 2, showing the pool of water depleted, and a moderately aggressive granular de-icing agent in the depression above the ice dam.

FIG. 4 shows an end view as in FIG. 3, including an end view of an elongate package of slow-acting granular de-icing agent on the roof above the ice dam.

FIG. 5 shows an end view as in FIG. 4 where the package of slow-acting granular de-icing agent has been turned such that the length of the package is extending up and down the roof.

FIG. 6 is a pictorial view of the building, showing multiple packages of the slow-acting de-icing agent above the ice dam after the ice dam has been breached by the very aggressive liquid de-icing agent and the moderately aggressive de-icing agent has further opened the breach path or paths.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

The basic objective of the invention is to provide a multiple step process, using corresponding multiple de-icing agents, to resolve the issues presented by ice dams which build up on sloped surfaces, such as on roofs.

And while the invention is described in the environment of dealing with an ice dam on the edge of a roof, the same methods can be used to treat ice dams on other sloped surfaces. Similarly, while the invention is described in terms of ice dams on the edge of sloped roof, where the roof slopes toward a side of the building, the same methods can be used to treat ice dams which form on roofs where the drains are located away from the edges of the roof; such as commercial buildings where drains are spaced about the area of what is generally considered a flat roof.

In practicing the methods of the invention, a first very aggressive de-icing agent is used to create an initial breach/passage in the ice dam. As a second step, a longer lasting de-icing agent is applied above the ice dam, to expand the breach/passage created by the very aggressive de-icing agent, and to generally begin substantially expanding the breach/passage through the ice dam. And depending on how much of the longer lasting de-icing agent is used, most or all of the mass of the ice dam which will be removed may be removed in a matter of several hours, or several days, depending on the aggressiveness of the longer lasting de-icing agent being used. Where a moderately aggressive de-icing agent is used as the second step, a slow-acting granular de-icing agent can be applied as a third step above the ice dam, in no particular order of timing, to further break down the ice dam as well as to avoid/attenuate future re-building of the ice dam by future flows of melted water running down the slope. The slow acting de-icing agent provides the ice avoidance feature by using a brine-producing material which dissolves slowly when in contact with water, to provide a brine, delivered to the location being treated over a relatively longer period of time, such as several months.

As used herein, a very aggressive de-icing agent is a liquid as applied, has a freezing point temperature no warmer than about −40 degrees F., optionally no warmer than about −50 degrees F., optionally no warmer than about −55 degrees F., optionally no warmer than about −75 degrees F., is soluble in diluting water, and remains liquid for the entire period of its use in breaching an ice dam.

As used herein a moderately aggressive de-icing agent is a particulate solid, of any form, typically having particles 1-6 mm diameter-effective volume, is fairly soluble in water, and wherein 50-60 grams, piled, dissolves in water in about 30 minutes to 12 hours, creating a brine which, when saturated, has a freezing point temperature no warmer than about −5 degrees F.

As used herein a slow acting de-icing agent is a particulate solid of any form, is slowly soluble in water, and wherein a 2 pound (0.9 kg) package of such de-icing agent, in a porous flexible sheet material package, dissolves slowly over a period of several months of cold weather, providing a brine which, when saturated, has a freezing point temperature no warmer than about +10 degrees F.

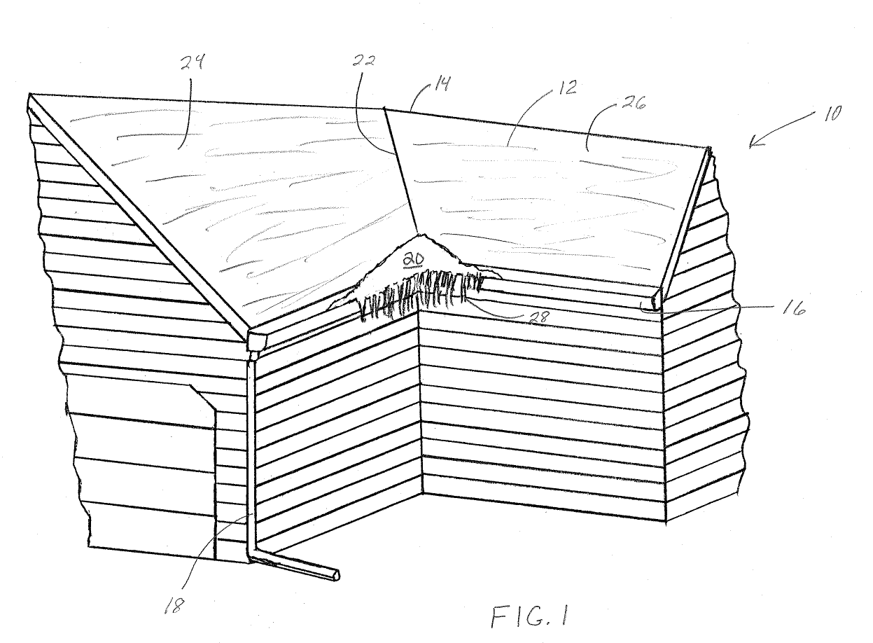

Referring now to the drawings, FIG. 1 shows a pictorial view of a portion of a typical residential building 10 which has snow 12 on the roof 14. The snow has begun to melt, and runs down the roof toward gutter 16, which leads to downspout 18. An ice dam 20 has formed in a valley 22 in the roof between first 24 and second 26 sections of the roof. The ice dam is illustrated as being severe in that the ice dam extends a substantial distance up the valley, and icicles 28 extend down from the outer edge of gutter 16.

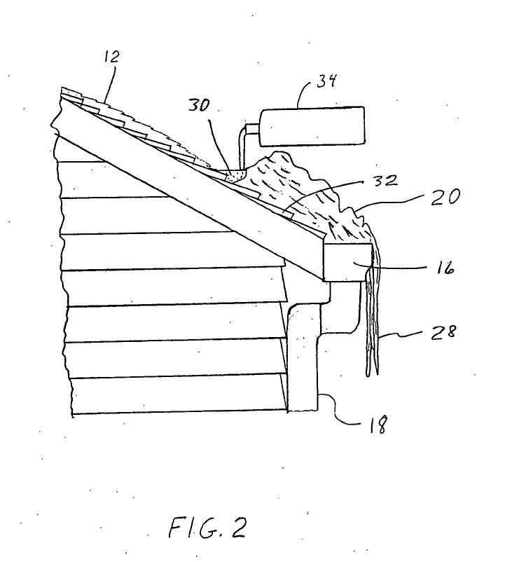

FIG. 2 shows the combination of the roof and the ice dam in edge view. A small pool 30 of water is shown as being trapped above the ice dam and can run under the roof shingles 32 above the ice dam. FIG. 2 shows a very aggressive liquid de-icing agent 34 being slowly poured from an e.g. 1 liter bottle onto the ice dam, at the top of the ice dam, such that the only direction of flow for the liquid de-icing agent is around the dam, through the ice dam, and/or between the ice dam and the roof shingles. Upon application of the very aggressive liquid de-icing agent, the agent breaches a typical ice dam in a matter of a few seconds, to up to about 15 minutes, typically in about 2 minutes to about 5 minutes, resulting in an aqueous liquid flow through the gutter and into and down the downspout. A rapid pour of the liquid de-icing agent would result in a substantial portion of the de-icing agent liquid flowing around or over the ice dam, which would at minimum waste material, and may not breach through or under the ice dam. Thus, the very aggressive de-icing agent is poured slowly onto the area being treated, which provides the most effective breach of the ice dam.

The freezing temperature of a suitable such very aggressive de-icing agent is no warmer than −40 degrees F., typically no warmer than −50 degrees, optionally no warmer than about −75 degrees F. The very aggressive de-icing agent is an aqueous solution whereby snow or ice encountered by the very aggressive de-icing agent can be quickly liquefied, thus replacing such solid material with liquid. Because the melting temperature is so low, the liquid de-icing agent readily creates a path down through the ice dam to the gutter, along the length of the gutter to the downspout, and down the downspout.

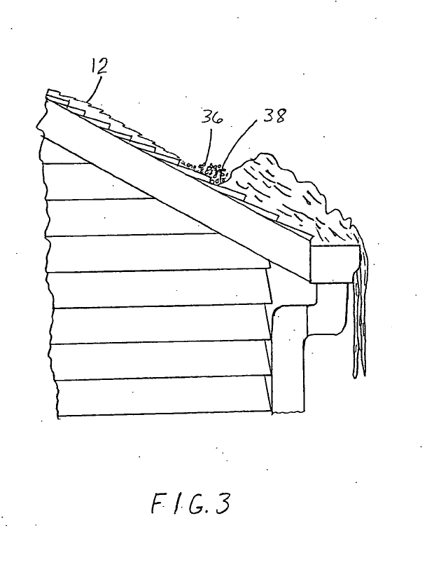

FIG. 3 shows the ice dam in edge view as in FIG. 2 after the very aggressive de-icing agent has breached the ice dam sufficient to enable flow of the water in the pool past and/or through the ice dam and to the gutter such that the pool of water above the ice dam has become depleted. FIG. 3 further shows a small quantity, e.g. about 2-4 pounds (0.9-1.8 kg), of a moderately aggressive granular de-icing agent 36 now disposed above the ice dam, in the depression 38 where the now-depleted pool of water had been, and where the very aggressive de-icing agent had been poured.

A suitable moderately aggressive de-icing agent responds to the water/snow/ice on the roof, by melting the ice or snow with which it is in contact, and creating a liquid brine with the resulting water. The brine has a relatively lower freezing temperature than plain water, for example no warmer than about −5 degrees F. to about −15 degrees F., optionally about −10 degrees F. Given that ice dams typically form when the ambient temperature is below the freezing temperature of +32 degrees F., given that the freezing temperature of a saturated brine of the moderately aggressive de-icing agent is typically about −5 degrees F. to about −15 degrees F., optionally about −10 degrees F., the brine, once created, tends to stay liquid. The liquid brine then flows, from the depression, down the roof and generally along the path created by the very aggressive de-icing agent, causing additional melting of ice in the ice dam along that path, and correspondingly expanding the flow path by which aqueous liquid such as melted snow and/or ice, can depart the ice dam area.

Depending on the severity of the ice dam, and the extent of the ice dam in the gutter and/or the downspout, a quantity of the very aggressive de-icing agent may be poured directly into the downspout and/or directly into the gutter to facilitate initiation of the liquid flow, as well as on application of the very aggressive de-icing agent to the ice dam on the roof. Where any extended length of the gutter is closed off by the ice dam, a suitable quantity of the very aggressive de-icing agent can be poured into the gutter at spaced intervals along the length of the so closed-off gutter, such as at 20 foot intervals. Since each ice dam is unique in its conformation, length, thickness, etc., the selection of locations and quantities for application of the very aggressive de-icing agent which is placed on/in the ice dam, is selected by the person applying the de-icing agent according to the conditions encountered at the ice dam site. If water has been flowing from near the ice dam into the building, such flow stops once the very aggressive de-icing agent has created an alternative flow path for the water, past the ice dam and into the gutter. In such instance of water flowing into the building, a relatively greater quantity of the very aggressive de-icing agent may preferably be used in order to quickly stop the flow of water into the building, thus to limit the amount of damage to the interior of the building.

Typically, the quantity of the very aggressive de-icing agent which is used is only that minimum amount which is required to get liquid flowing from the ice dam to the downspout, in combination with cessation of any flow of water into the building. A typical quantity of the very aggressive de-icing agent, which is applied at a given application point, is about 1-2 cups (250-500 ml) of the liquid. Once liquid/water is flowing through the downspout and wherein water is not flowing into the building, the first step of breaching the ice dam has been completed, and no further use of the very aggressive liquid de-icing agent is needed.

Typically, the flow path(s) created by the very aggressive liquid de-icing agent are relatively small in cross-section. Since the very aggressive de-icing agent is liquid, gravity promptly moves substantially all of the very aggressive de-icing agent past the ice dam and no substantial portion of that liquid de-icing agent remains in the flow paths, whereby the effect of the very aggressive de-icing agent is short term, typically limited to less than an hour from the time the very aggressive liquid de-icing agent is first applied. Accordingly, the flow paths created by the very aggressive de-icing agent are subject to being re-closed by subsequent flow of melting water which approaches the respective part of the ice dam.

The role of the moderately aggressive de-icing agent is to continue to keep open the flow paths created by the very aggressive de-icing agent, to expand those flow paths, and to create additional flow paths through and/or around the ice dam. In fulfilling those roles, the moderately aggressive de-icing agent combines with water with which it comes into contact on the roof to make a liquid brine, and also combines with snow and ice with which it comes into contact, depressing the freezing point temperature of such combinations and correspondingly creating a liquid brine, which flows as a trickle, initially along the paths created by the very aggressive de-icing agent, expanding those initially-created flow paths, as well as potentially creating new flow paths through the ice dam. Thus, the user places the moderately aggressive de-icing agent in one or more locations, whether a loose pile of granules or as a pre-packaged quantity in a porous sheet material, at the top of the ice dam, typically in the area or areas where the very aggressive de-icing agent was used to make one or more breaches in the ice dam. For example, a pile of e.g. 50-60 grams of loose granules of the moderately aggressive granular de-icing agent, suitably in contact with snow or ice, or a small amount of liquid water, provides a suitable trickle flow of brine for a period of a few hours, such as about 4 hours to about 24 hours, or longer. The actual quantity of the moderately aggressive de-icing agent which is placed at a given location depends on the length of the path through the ice dam from the top of the ice dam to the gutter, and along the gutter to the downspout, as well as by the mass of the ice dam being treated. Similarly, the number of locations where the moderately aggressive de-icing agent is placed depends on the spread/length/extent of the ice dam. Larger ice dams require more material at more locations, while relatively smaller ice dams do not require use of as much material.

Especially, where the very aggressive de-icing agent has been used in the gutter as well as on the ice dam on the roof, and/or where a substantial length of the gutter is clogged with ice, and/or where there is a timing urgency to removal of the ice from the gutter quickly, deposits of the moderately aggressive de-icing agent can be made in the gutter, e.g. at the same spacings as the very aggressive de-icing agent, or at any other spacings which seem appropriate according to the needs of the situation.

From another perspective, some building owners want the entirety of the ice dam removed in a relatively short time. Others are satisfied that the ice dam has been breached and that there is a good prospect, through use of the moderately aggressive de-icing agent, or a slow acting de-icing agent, that no liquid will enter the building from that ice dam. So, the quantity of material used, especially the moderately aggressive de-icing agent or the slow acting de-icing agent, depends on the amount of ice, the fraction of that ice which the building management/owner desires be removed, and the expected timing of-such removal.

Given a typical deposit of e.g. 50-60 grams of the moderately aggressive de-icing agent, by the time the entire deposit of the moderately aggressive de-icing agent has been so consumed, e.g. over a period of a few hours, a substantial path has been created in the typical ice dam, and if the ice dam is relatively smaller, the entire ice dam may have been substantially removed from the roof, and potentially removed from the gutter and downspout. In any event, following proper treatment of a particular ice dam with the very aggressive liquid de-icing agent and the moderately aggressive granular de-icing agent, the blockage to and through the downspout has been effectively cleared, and the prospect of the ice dam again backing up water in a pool on the roof in the near future is substantially reduced, and is typically eliminated.

Depending on the severity of the ice dam problem, and the expectations and risk tolerance of the building management, a slow-acting de-icing agent may be placed on the roof at locations above the position of the ice dam at any time during or after the treatment of the ice dam with the very aggressive de-icing agent and the moderately aggressive de-icing agent in order to reduce the prospects for future build-up of such ice dam(s). Such slow acting de-icing agent is typically packaged in a closed porous flexible container. Such container is typically made from a strong porous fabric, such as a woven or non-woven sheet material. Such sheet material is sufficiently porous to readily admit/receive water running down the surface of the roof and to wick that water, e.g. by surface tension through the porous packaging material, into the interior of the package, and into contact with the slow acting de-icing agent. Such water absorbs a portion of the slow acting de-icing agent, creating a brine having a freezing temperature, when saturated, of about +10 degrees F.

In some situations, such as where the mass of the ice dam is less severe, or where there may be a lesser quantity of snow and/or ice left on the roof when the treatment is being applied, the risk of plugging of the paths created by the very aggressive de-icing agent, in the near future can appear to be relatively smaller. In such situations, use of the moderately aggressive de-icing agent may not be needed whereby, after the ice dam is breached by the very aggressive liquid, only the slow acting de-icing agent is employed to prevent future stoppage of flow of melting run-off around or through the ice dam. For example, a package 40 of the slow acting granular de-icing agent can be placed on the roof at the top of the ice dam or above the ice dam. As water seeps into the package of the slow acting de-icing agent, the water dissolves some of the slow acting de-icing agent, forming a brine having the recited freezing temperature of about +10 degrees F. That brine runs down the roof, acting on any snow and/or ice it encounters. As the brine encounters the ice dam, the brine interacts with the ice, depressing the melting temperature of the ice molecules, and melting the ice molecules, thus gradually liquefying substantial portions of the ice dam such that the solid ice dam is gradually liquefied, and carried down the roof, along the gutter and downspout, and thus off the roof.

Thus, where time is not necessarily of the essence, the ice dam, once breached by the very aggressive de-icing agent, can be treated with only a second step of applying the slow acting de-icing agent. And if, during treatment with the slow acting de-icing agent, the actual observed progress is slower than desired and/or expected, deposits of the moderately aggressive de-icing agent can be made in suitable locations at the ice dam, while also leaving the slow acting de-icing agent in place, to speed up the process.

As a preventative measure, a roof can be treated only with the slow acting de-icing agent. For example, a 2-pound (0.9 kg) package 40 of a slow acting de-icing agent can be placed at a strategic location on a roof thereby to prevent formation of ice dams generally throughout the course of a winter season in a temperate climate location.

In some situations where there is no urgency to resolving an ice dam issue, such as where the ice dam has just started to form and has yet not become a functional problem, the ice dam location can be proactively treated without use of the very aggressive liquid de-icing agent. Namely, one or more packages of the slow acting de-icing agent can be placed at strategic locations of the roof or in the gutter, with additional placements of the moderately aggressive de-icing agent e.g. at the top edge of the ice dam. The moderately aggressive de-icing agent can also, or alternatively, be placed in the corresponding gutter or downspout if either the gutter or downspout is blocked.

The slow acting de-icing agent, as contemplated for use in the invention, is optionally packaged in a flexible sheet material configured as an elongate pillow-shaped package. Illustratively, and without limitation, a such package 40 is about 14 inches (35.5 cm) long by about 5 inches (12.7 cm) wide by about 1 inch (2.5 cm) thick. Such package of the slow acting de-icing agent can be substantially larger, or substantially smaller, than the above-recited size of 14 inches (35.5 cm) by 5 inches (12.7 cm) by 1 inch (2.5 cm), depending on the specific application for the subject package. The benefits of the packaging for the slow acting de-icing agent is that such packaging facilitates the application of the slow acting de-icing agent to the roof in larger quantities than the moderately aggressive de-icing agent. For example, while the moderately aggressive de-icing agent is generally applied in relatively smaller quantities of about 1-4 pounds (0.45-1.8 kg) per placement, the slower acting de-icing agent is generally applied in quantities of 1-20 pounds (0.4-9 kg) or more. A typical such application of the slow acting de-icing agent is about 2 pounds (0.9 kg) in a package having the above-noted exemplary dimensions.

Such 2 pound (0.9 kg) package, once placed, can be left on the roof throughout the course of the winter season. The suggested sizing of the package will, in many instances, last the entire winter season, providing preventative measures against formation of ice dams at its locus of placement. If the material in the package has not been entirely used up by the end of the winter season, the package can be removed from the roof, stored in a dry location until the arrival of the next winter season, and re-placed on the roof for continued use in preventing formation of ice dams the following winter.

Another reason for packaging the slow acting de-icing agent in pouches/packages, is ease of handling. Considering the inclement weather inherent when methods and products of the invention are used, the user is accessing the roof of a building under relatively hazardous conditions. Any measures which can be taken to facilitate the application of the ice-dam breaching products contribute to the safety of the worker. Thus, the product should be packaged in containers which are easily handled, and whereby product can easily be placed in desired locations with as little effort as possible so as to limit the user's exposure to strenuous situations in the slippery and cold environment of such working conditions. The above described package of e.g. 2 pounds (0.9 kg) of the slow acting material is easy to handle, as one or multiple flexible pouches can be carried in a large pocket, or in a readily handled general container such as a bucket which can be hoisted after the worker is in an elevated location on the roof, or on a ladder.

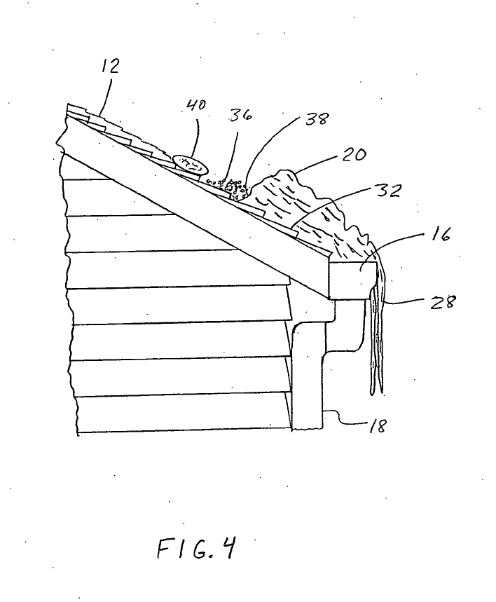

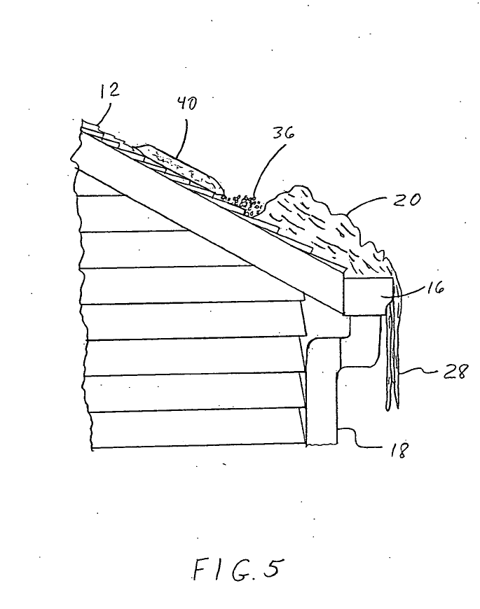

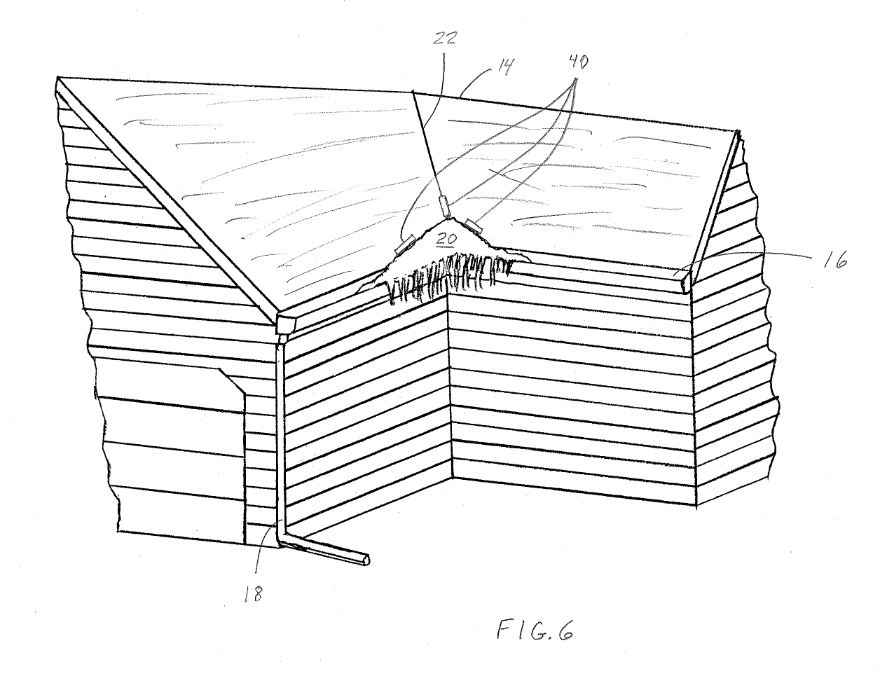

FIG. 4 shows a package of the slow acting de-icing agent oriented with the length of the package extending generally horizontally across the roof, thus to provide maximum exposure of the package to water running down the roof. FIG. 5 shows the package of the slow acting de-icing agent oriented with the length of the package extending up and down the slope of the roof, whereby the package is subjected to a lesser width of the roof surface. FIG. 6 shows two packages 40 of the slow acting de-icing agent extending at angles which follow the oblique angle of the top edge of the ice dam, and a third package oriented such that the length of the package extends up and down valley 22, thus to intercept water which moves toward, or in, the valley.

Given the nature of use, namely the short term role of the moderately aggressive de-icing agent, a given placement of a quantity of the moderately aggressive de-icing agent, assuming sufficient moisture on the roof to dissolve such de-icing agent, is typically used up, consumed, completely dissolved in water and off the roof, within a few hours, such as 30 minutes to 12 hours from the time the moderately aggressive de-icing agent is placed in use e.g. on a roof.

Similar to the slow acting granular de-icing agent, the moderately aggressive de-icing agent can be packaged in the same, or a similar, porous sheet material. Since the role of the moderately aggressive de-icing agent is limited to relatively shorter-acting remedies, specific to breaking down ice dams, the moderately aggressive de-icing agent, for each location of use, is generally used in smaller quantities than a given placement of the slow acting de-icing agent. Thus, where about 2 pounds (0.9 kg) of the slow acting agent is typically placed in a given location, about 2-4 pounds (0.9 kg) of the moderately aggressive de-icing agent is used in a given location. Thus, a typical package of the moderately aggressive de-icing agent is quite smaller than a typical package of the slow acting de-icing agent. Further, since the moderately aggressive de-icing agent is expected to act quickly when applied, the packaging materials necessarily more aggressively attract water across the package material boundary and into contact with the moderately aggressive de-icing material, in order to ensure creation of the brine which is needed to maintain and grow the flow paths necessary for further drainage from the e.g. roof.

Whether for the slow acting de-icing material or for the moderately aggressive de-icing material, the packaging material is selected as one which is porous for admission of water, wherein the pores defined by the material are sufficiently small to retain the granular de-icing agent therein, yet sufficiently sized to accommodate and allow water to flow freely through the packaging material. The packaging material must be such that the packaging material is not chemically attacked by the de-icing material contained therein. Preferably, the packaging material is not long-term detrimental to the environment. Thus, the packaging material is typically a fibrous woven or non-woven which breaks down, biodegrades, upon prolonged exposure to sunlight. Such packaging material thus breaks down on the roof after the contained chemicals have been fully consumed, and thus becomes light enough to be easily blown off the roof by wind. For packaging the moderately aggressive de-icing agent, where the period of use, during which the packaging material need contain/retain the de-icing agent is short, the packaging material can lose its product-holding strength in a period of about an hour after becoming saturated with water, and can be slowly soluble in water so as to effectively disintegrate over a period of about an hour to about one day after becoming saturated with water.

The invention further contemplates a method wherein the de-icing agent applied in the second step is a combination of a moderately aggressive de-icing agent and a slow acting agent enclosed in a single outer packaging material. The moderately aggressive de-icing agent, or the slow acting de-icing agent, or both, can be separately packaged, or packaged in separate cavities, inside the outer packaging material. In the alternative, both materials may be comingled in a single package cavity. The purpose of the combination package is generally one of ease of use, whereby the user can place a single package and get the advantage of the materials of both de-icing agents.

In such use to clear an ice dam, the user typically uses the very aggressive de-icing agent to breach the ice dam, and uses the combination package to both further open the flow paths and to maintain those flow paths open. A further advantage of the combination package is that the placement of a single package necessarily positions the slow acting de-icing agent in exactly the right location, aligned with, and to take advantage of, the flow paths which have already been opened up by the moderately aggressive de-icing agent.

While a number of chemical compositions can be recited as the de-icing agents used in the methods of the invention, preferred chemicals are non-toxic to vegetation in the amounts used. So while a number of chemicals are recited herein, the acetate salts are preferred for their non-toxicity to vegetation in the amounts contemplated for use herein.

Thus, there can be mentioned, for use as the very aggressive de-icing agent, an aqueous solution of potassium acetate, optionally a saturated aqueous solution of potassium acetate having a freezing point temperature of about −75 degrees F. There can also be mentioned unsaturated solutions of potassium acetate having freezing point temperatures no warmer than −40 degrees F., optionally no warmer than −50 degrees F., optionally no warmer than −55 degrees F. There can also be mentioned liquid compositions comprising combinations of potassium acetate and sodium acetate in water solution, having freezing point temperature no warmer than −40 degrees, optionally no warmer than −50 degrees F., optionally no warmer than −55 degrees F.

As moderately aggressive de-icing agents, there can be mentioned, without limitation, compositions of magnesium chloride and calcium chloride. However, preference is noted for sodium acetate, and any other de-icing agent which may act in similar time period without the run-off causing damage to local vegetation. A typical sodium acetate is granulated and has particles which, if spherical, contain about the same mass of material as a spherical particle about 1-6 mm diameter.

As the slow acting de-icing agents, there can be mentioned, without limitation, compositions of sodium chloride and potassium chloride. However, preference is noted for calcium magnesium acetate, and any other de-icing agent which may act in similar time period without the run-off causing damage to local vegetation. A typical calcium magnesium acetate is granulated and has particles which, if spherical, contain about the same mass of material as a spherical particle about 0.5-3 mm diameter.

For all the de-icing agents mentioned herein, known anti-corrosion agents, used to protect metal surfaces, and other additives commonly employed in de-icing agents, are contemplated as being used in all of such de-icing agents, and the following claims similarly contemplate minor quantities of such additives. Because the moderately aggressive de-icing agent is used as a problem solver as opposed to a problem preventer, placement of the moderately aggressive de-icing agent is selected after a problem area/ice dam is detected.

The granular de-icing agents contemplated for use herein are stoichiometric compositions or generally stoichiometric compositions, according to the prevalent valences of the respective moieties in such compositions.

Although the invention has been described with respect to various embodiments, it should be realized this invention is also capable of a wide variety of further and other embodiments within the spirit and scope of the appended claims.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A method of controlling an ice dam at a given location on a sloped surface during an icy period of time, the ice dam having a top, the method comprising:
(a) applying a very aggressive liquid de-icing agent, having a freezing point temperature colder than about −40 degrees Fahrenheit, to the ice dam in such amount that the liquid de-icing agent promptly breaches the ice dam and begins a flow of liquid from the ice dam; and
(b) applying, to the ice dam, an effective amount of a moderately aggressive, granular de-icing agent, the moderately aggressive, granular de-icing agent, in combination with atmospheric water, developing a liquid brine which is effective to cause melting of at least a further portion of the ice dam, in addition to the breach effected by the very aggressive liquid de-icing agent.

2. A method as in claim 1 wherein the sloped surface is part of a roof of a building, at least a portion of the ice dam being on the roof, the building further comprising a gutter receiving water from the edge of the roof, and a downspout receiving such water from the gutter, the applying of the very aggressive liquid de-icing agent to the ice dam comprising applying the very aggressive liquid de-icing agent to the ice dam at at least one of (i) at the ice dam on the roof, (ii) at the ice dam in the gutter, and (iii) at the ice dam in the downspout.

3. A method as in claim 1, further comprising, in addition to applying the moderately aggressive, granular, de-icing agent and the very aggressive liquid de-icing agent, applying a slow-acting de-icing agent to the sloped surface on, or above, the ice dam location, the slow-acting de-icing agent, in combination with atmospheric water, gradually liquefying, and reaching the ice dam location, thus attenuating any tendency for further development of an ice dam at such location.

4. A method as in claim 3 comprising placing, on the roof, as the granular slow-acting deicing agent, a packaged product comprising at least the effective amount of granular slow-acting de-icing agent in a closed porous flexible packaging container.

5. A method as in claim 1 wherein the very aggressive liquid de-icing agent comprises potassium acetate in water and having a freezing point temperature no warmer than about −50 degrees Fahrenheit.

6. A method as in claim 5 wherein the very aggressive liquid de-icing agent comprises potassium acetate and sodium acetate in water.

7. A method as in claim 1 wherein the moderately aggressive, granular de-icing agent comprises sodium acetate and has a freezing point temperature in a water solution of no warmer than about −10 degrees Fahrenheit.

8. A method as in claim 3 wherein the slow acting de-icing agent comprises calcium magnesium acetate.

9. A method as in claim 2, comprising applying the very aggressive liquid de-icing agent to the ice dam both at the roof and in the gutter downstream from the locus of application on the roof.

10. A method as in claim 9, an extension of the ice dam, or an additional ice dam, being disposed in the downspout downstream from the ice dam on the roof, the method further comprising also pouring the very aggressive liquid de-icing agent into the downspout.

11. A method as in claim 9, an extension of the ice dam, or an additional ice dam, being disposed in the gutter downstream from the ice dam on the roof, the method further comprising also pouring the very aggressive liquid de-icing agent into the corresponding gutter, optionally at spaced locations between the ice dam and the downspout, the spacings being effective to start flow of liquid to the downspout from a location in the gutter proximately below the ice dam.

12. A method as in claim 1, including applying, to the sloped surface, an amount of the granular moderately aggressive de-icing agent, sufficient to accommodate continued at least temporary flow of liquid through the ice dam after the flow of the very aggressive liquid de-icing agent has ceased.

13. A method as in claim 4, further comprising removing the package, containing a remainder portion of the slow-acting de-icing agent, from the roof at the end of the icy period of time, and re-positioning the same package of slow-acting de-icing agent on the roof proximate the beginning of a next icy period of time.

14. A method as in claim 1 wherein the sloped surface is defined as part of a gutter below a sloped roof, at least a portion of the ice dam being in the gutter, the method comprising pouring the very aggressive liquid de-icing agent into the gutter such that the very aggressive liquid de-icing agent reaches, and breaches, the ice dam, and applying the moderately aggressive granular de-icing agent into/onto at least one of the gutter, or the roof above the gutter.

15. A method as in claim 14, further comprising, in addition to applying the very aggressive liquid de-icing agent and the moderately aggressive de-icing agent, applying a slow-acting granular de-icing agent to at least one of the gutter or the roof above the gutter, the slow-acting granular de-icing agent, in combination with atmospheric water, gradually liquefying and reaching the ice dam location, thus attenuating any tendency for further development of an ice dam at such location.

16. A method as in claim 13, the very aggressive liquid de-icing agent comprising potassium acetate in water and having a freezing point temperature no warmer than about −40 degrees Fahrenheit.

17. A method as in claim 13, the very aggressive liquid de-icing agent comprising potassium acetate and sodium acetate in water.

18. A method as in claim 14, comprising pouring the very aggressive liquid de-icing agent into the gutter at spaced locations upstream of a corresponding downspout which is connected to the respective gutter.

19. A method as in claim 14, an extension of the ice dam, or an additional ice dam, being disposed in a downspout downstream from the ice dam in the gutter, the method further comprising also pouring the very aggressive liquid de-icing agent into the downspout.

20. A method as in claim 1 wherein the sloped surface is defined as part of a gutter below a sloped roof, at least a portion of the ice dam being in the gutter, the method comprising applying the moderately aggressive de-icing agent into/onto at least one of (i) the gutter, and (ii) the roof above the gutter, in an amount sufficient to accommodate continued at least temporary flow of liquid brine through the ice dam after the flow of very aggressive liquid de-icing agent has ceased.

21. A method of controlling an ice dam at a given location on a sloped surface during an icy period of time, the ice dam having a top, the method comprising:
(a) applying a very aggressive liquid de-icing agent, having a freezing point temperature colder than −40 degrees Fahrenheit, to the ice dam in such amount that the liquid de-icing agent promptly breaches the ice dam and begins a flow of liquid from the ice dam; and
(b) applying, to the ice dam, an effective amount of a slow acting, granular de-icing agent, the slow acting, granular de-icing agent, in combination with atmospheric water, developing a liquid brine which is effective to cause melting of at least a further portion of the ice dam, in addition to the breach effected by the very aggressive liquid de-icing agent.

22. A method as in claim 21 wherein the sloped surface is part of a roof of a building, at least a portion of the ice dam being on the roof, the building further comprising a gutter receiving water from the edge of the roof, and a downspout receiving such water from the gutter, the applying of the very aggressive liquid de-icing agent to the ice dam comprising applying the very aggressive liquid de-icing agent to the ice dam at at least one of (i) at the ice dam on the roof, (ii) at the ice dam in the gutter, and (iii) at the ice dam in the downspout.

23. A method as in claim 21 wherein the very aggressive liquid de-icing agent comprises potassium acetate in water and having a freezing point temperature no warmer than about −40 degrees Fahrenheit.

24. A method as in claim 23 wherein the very aggressive liquid de-icing agent comprises potassium acetate and sodium acetate in water.

25. A method as in claim 21 wherein the slow acting, granular de-icing agent comprises calcium magnesium acetate and has a freezing point temperature in a saturated water solution of no warmer than about +10 degrees Fahrenheit.

26. A method as in claim 22 wherein the slow acting de-icing agent comprises calcium magnesium acetate.

27. A method as in claim 23, comprising applying the very aggressive liquid de-icing agent to the ice dam both at the roof and in the gutter downstream from the locus of application on the roof.

28. A method as in claim 27, an extension of the ice dam, or an additional ice dam, being disposed in the downspout downstream from the ice dam on the roof, the method further comprising also pouring the very aggressive liquid de-icing agent into the downspout.

29. A method as in claim 27, an extension of the ice dam, or an additional ice dam, being disposed in the gutter downstream from the ice dam on the roof, the method further comprising also pouring the very aggressive liquid de-icing agent into the corresponding gutter, optionally at spaced locations between the ice darn and the downspout, the spacings being effective to start flow of liquid to the downspout from a location in the gutter proximately below the ice dam.

30. A method as in claim 21, including applying, to the sloped surface, an amount of the granular slow acting de-icing agent, sufficient to accommodate continued relatively longer term flow of liquid through the ice dam after the flow of the very aggressive liquid de-icing agent has ceased.

31. A method as in claim 21, comprising placing the slow acting de-icing agent on the sloping surface as a packaged product, packaged in a flexible sheet material, the method further comprising removing the package, containing a remainder portion of the slow-acting de-icing agent, from the sloped surface at the end of the icy period of time, and re-positioning the same package of slow-acting de-icing agent on the roof proximate the beginning of a next icy period of time.

32. A method as in claim 21 wherein the sloped surface is defined as part of a gutter below a sloped roof, at least a portion of the ice dam being in the gutter, the method comprising pouring the very aggressive liquid de-icing agent into the gutter such that the very aggressive liquid de-icing agent reaches, and breaches, the ice dam, and applying the water permeable package, containing the slow acting granular de-icing agent, into/onto at least one of the gutter, or the roof above the gutter.

33. A method as in claim 32, the very aggressive liquid de-icing agent comprising potassium acetate in water and having a freezing point temperature no warmer than about −40 degrees Fahrenheit.

34. A method as in claim 33, the very aggressive liquid de-icing agent comprising potassium acetate and sodium acetate in water.

35. A method as in claim 21 wherein the sloped surface is defined as part of a gutter below a sloped roof, at least a portion of the ice dam being in the gutter, the slow acting de-icing agent comprising calcium magnesium acetate, in the gutter, having a freezing point temperature, in a saturated water solution, of no warmer than about +10 degrees Fahrenheit.

36. A method as in claim 32, comprising pouring the very aggressive liquid de-icing agent into the gutter at spaced locations upstream of a corresponding downspout which is connected to the respective gutter.

37. A method as in claim 32, an extension of the ice dam, or an additional ice dam, being disposed in a downspout downstream from the ice dam in the gutter, the method further comprising also pouring the very aggressive liquid de-icing agent into the downspout.

38. A method as in claim 21 wherein the sloped surface is defined as part of a gutter below a sloped roof, at least a portion of the ice dam being in the gutter, the method comprising applying the slow acting granular de-icing agent into/onto at least one of (i) the gutter, and (ii) the roof above the gutter, in an amount sufficient to accommodate continued flow of liquid brine through the ice dam after the flow of very aggressive liquid de-icing agent has ceased.

39. In a gutter and downspout combination, receiving run-off from a roof, a method of breaching an ice dam in the gutter and downspout combination and thereby re-starting flow of aqueous liquid through the gutter and downspout combination, the method comprising:
(a) as a first step, applying a very aggressive liquid de-icing agent, having a freezing point temperature colder than −40 degrees Fahrenheit, to the ice dam, including on any ice dam element in the gutter, at spaced locations along the length of the gutter, as well as on any ice dam blockage in the downspout, in such amount that the very aggressive liquid de-icing agent breaches the ice dam and begins a flow of liquid from the ice dam; and
(b) applying, as a second step, and in no particular order, an effective amount of either a moderately aggressive, granular de-icing agent or a slow acting de-icing agent, at at least one of
(i) a relatively upstream portion of the gutter or
(ii) a portion of the roof proximate a relatively upstream portion of the gutter, the moderately aggressive, granular de-icing agent, or slow acting granular de-icing agent, being effective, in combination with liquid water, snow, or ice, with which such moderately aggressive de-icing agent, or slow acting granular de-icing agent, is in contact, to develop a liquid brine which causes melting of the ice dam sufficient to accommodate continued at least temporary flow of liquid through or around the ice dam.

40. A method as in claim 39 wherein the de-icing agent applied in the second step is a moderately aggressive granular de-icing agent, further comprising, in addition to applying the moderately aggressive, granular de-icing agent and the very aggressive de-icing agent, applying, as a third step, a such slow-acting granular de-icing agent to the roof proximate, and above, the gutter and upstream from the downspout.

41. A method as in claim 23 comprising placing, on the roof, as the granular slow-acting de-icing agent, a packaged product comprising at least an effective amount of the granular slow-acting de-icing agent in a closed porous flexible packaging container.

42. A method as in claim 39 wherein the very aggressive liquid de-icing agent comprises potassium acetate in a water solution and has a freezing point temperature no warmer than about −40 degrees Fahrenheit.

43. A method as in claim 42 wherein the very aggressive liquid de-icing agent comprises potassium acetate and sodium acetate in a water solution.

44. A method as in claim 40 wherein such granular moderately aggressive de-icing agent as is used comprises sodium acetate and has a freezing point temperature in a saturated water solution of no warmer than about −10 degrees Fahrenheit.

45. A method as in claim 40 wherein such granular moderately aggressive de-icing agent as is used comprises calcium magnesium acetate and has a freezing point temperature in a saturated water solution of no warmer than about +10 degrees Fahrenheit.

46. A product combination, comprising:
(a) a first container comprising a very aggressive liquid de-icing agent having a freezing point temperature colder than about −40 degrees Fahrenheit;
(b) a second container comprising one or more of a moderately aggressive, granular de-icing agent having a freezing point temperature no warmer than about −10 degrees Fahrenheit, or a slow acting de-icing granular de-icing agent having a freezing point temperature no warmer than about +10 degrees Fahrenheit; and
(c) instructions specifying pouring a quantity of the very aggressive de-icing agent such that the very aggressive de-icing agent arrives at an ice dam and thereby initiates liquid flow in breach of the ice dam, and placement of the respective moderately aggressive de-icing agent and/or slow acting de-icing agent relative to the ice dam so as to maintain flow of a liquid brine after depletion of that flow which was initiated by the very aggressive liquid de-icing agent.

47. A product combination as in claim 46, the second container comprising such moderately aggressive de-icing agent, the product combination further comprising a slow-acting granular de-icing agent in a second closed package comprising porous flexible sheet material, the instructions specifying placement of the closed package of the slow-acting de-icing agent relative to the ice dam so as to maintain capacity for low-rate liquid flow from the closed package of slow-acting de-icing agent, with reduced potential for ice dam build-up, after depletion of the moderately aggressive de-icing agent.

48. A product combination as in claim 46, the second container comprising a combination of both such moderately aggressive de-icing agent and such slow acting de-icing agent, the instructions specifying placement of the closed package so as to provide for a continuing flow of liquid brine after depletion of an applied quantity of the very aggressive liquid de-icing agent.

49. A product combination as in claim 45 wherein the very aggressive liquid de-icing agent is a solution of potassium acetate in water and has a freezing point temperature no warmer than about −40 degrees Fahrenheit.

50. A product combination as in claim 49 wherein the very aggressive liquid de-icing agent is a solution of potassium acetate and sodium acetate in water.

51. A product combination as in claim 47 wherein the slow acting granular de-icing agent comprises calcium magnesium acetate granules and has a freezing point temperature, in a saturated water solution, no warmer than +10 degrees Fahrenheit.

52. A product combination as in claim 46 wherein the moderately aggressive, granular de-icing agent comprises sodium acetate granules and has a freezing point temperature, in a saturated water solution, no warmer than about −10 degrees Fahrenheit.
